(19) United States
(12) Patent Application Publication
(10) Pub. No.: US 2013/0004066 A1
(43) Pub. Date: Jan. 3, 2013

(54) DETERMINING A BACKGROUND COLOR OF A DOCUMENT

(76) Inventors: David G. Butler, Eagle, ID (US); Adam J. Snyder, Bend, OR (US); Kenneth K. Smith, Boise, ID (US); Teresa A. Triolo, Boise, ID (US)

(21) Appl. No.: 13/175,864

(22) Filed: Jul. 3, 2011

(51) Int. Cl. G06K 9/00

(52) U.S. Cl. 382/165

(57) ABSTRACT

A media reproduction device determines a background color of a document.

### BACKGROUND

When scanning documents for copy or fax, the document is assumed to have a white background. Clipping techniques are applied to the document to yield consistent, monotone white backgrounds in the resulting images. This provides consistency for high rates of compression in run-length encoding schemes and results in clean-looking copies of documents. These techniques, however, are ineffective with different types of documents.

### BRIEF DESCRIPTION OF THE DRAWINGS

FIG. 1 is a method to determine a background color of a document in accordance with an example embodiment.

FIG. 2 is a method to use histograms to change pixels in a background of a document to have a single color in accordance with an example embodiment.

FIG. 3 is a histogram of pixel values extracted from a document to determine the background color in accordance with an example embodiment.

FIG. 4 is a block diagram of a media reproduction device that determines a background color of a document in accordance with an example embodiment.

### DETAILED DESCRIPTION

Example embodiments are apparatus and methods that determine a background color of a document and change pixels in the background to have a single color. This enables color documents to be efficiently scanned, compressed, and transmitted or copied.

Clipping techniques applied to black and white documents are ineffective when the original document is printed on colored paper. Slight variations in the color paper as well as scanner induced noise result in a random array of similar pixels that thwart run-length encoding schemes, increase compressed file size, and increase facsimile transmission times.

Example embodiments use histograms obtained from pixels in margin areas of a document to determine the background color. Red, green, blue (RGB) pixels are converted to luminance-chrominance color space. If the background is determined to be colorful, by checking the chrominance values against a threshold value, a non-linear transform is applied to pixels within a range of the background color to remove noise from the background or remove the entire background itself. This process results in clear, highly compressible documents that are acceptable for further processing, such as faxing, scanning, copying, and performing optical character recognition (OCR). This process also saves toner when performing copying and reduces blurred edges and processing time.

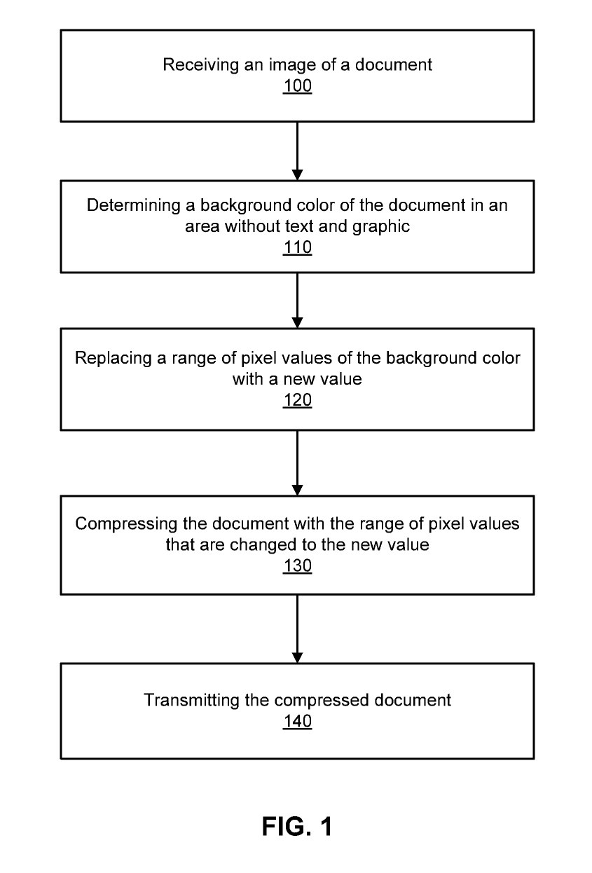

FIG. 1 is a method to determine a background color of a document in accordance with an example embodiment.

According to block 100, an image of a color document is retrieved or received. For example, the document is scanned at an electronic device to generate a color image of the document. Alternatively, the document is downloaded to or received at the electronic device. For example, the electronic device obtains a portable document format (PDF) image from a peripheral device (such as a camera), portable memory card, or a network (such as downloading the image from the internet or receiving the image as an email).

In an example embodiment, the original document is scanned to produce a RGB color image. The RGB color image is converted to a luminance chrominance color space using a 3×3 matrix multiply plus matrix addition operation. Chrominance information is checked against a threshold that indicates that the scanned image contained color information, and not just marginally gray information. When background regions of the scanned image are determined to be colorful, colorful pixels are converted to either white or a low-noise variant of the color.

An example of a 3×3 matrix multiply plus offset matrix is to convert from RGB color space to Y-Cr-Cb color space as follows:

$$[ \begin{matrix}A 00 & A 01 & A 02 \\ A 10 & A 11 & A 12 \\ A 20 & A 21 & A 22\end{matrix} ] \times [ \begin{matrix}R \\ G \\ B\end{matrix} ] + [ \begin{matrix}C 0 \\ C 1 \\ C 2\end{matrix} ] = [ \begin{matrix}Y \\ Cr \\ Cb\end{matrix} ]$$

Here, RGB represents the quantized pixel values as read from the scanning elements—these are the input variables. A00 to A22 represent the multiplicative coefficients used for the color space conversion—these are the constraints. C0 to C2 represent the offsets for the YCrCb color space—these are constants. Y, Cr, Cb represent the output of the equation—these are the pixel representation in Luminance-Chrominance space.

It is also possible to utilize an average color intensity of Y′=(R+G+B)/3. Then the operations described herein are applied to Y′. Other methods of converting from RGB color space to different luminance-chrominance spaces are also available.

According to block 110, a background color of the document is determined from an area without text and graphics. One example embodiment examines margins, edges, or corners of the document that are outside a printed area and uses histograms to determine the color in this area. The histograms determine a commonly occurring or dominant color or shade in this area.

According to block 120, a range of pixel values of the background color is replaced or changed with a new value. Once the background color is determined, pixels within a range or percentage of this background color are snapped to a new value, such as the color white or another single color. For example, suppose the background color is determined to be yellow with a median pixel value of “X.” Pixels in the document are changed to this median pixel value if the pixels are within a range of X or a percentage of X. Alternatively, pixels in the document are changed to another color (such as white) if the pixels are within the range or percentage of X.

According to block 130, the document is compressed with the range of pixel values that are changed to the new value.

According to block 140, the compressed document is transmitted, such as being sent via facsimile or sent to a computer or peripheral device. The compressed document can also be stored in memory of the electronic device, printed by the electronic device, saved to a portable memory device, or sent over a network (such as emailing the document).

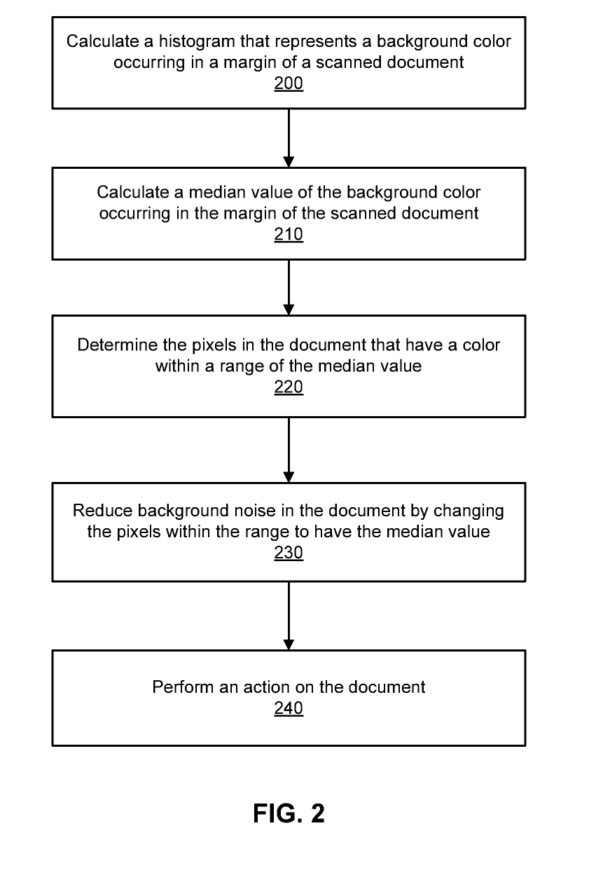

FIG. 2 is a method to use histograms to change pixels in a background of a document to have a single color in accordance with an example embodiment.

According to block 200, a histogram is calculated that represents a background color occurring in a margin of a scanned document. Alternatively, the histogram can be calculated in other areas of the document, such as areas outside of the margin not having text or graphics.

In one example embodiment, the background color of the document (such as a piece of paper or other physical medium) is determined by examining the histogram of the full-page image and by determining a prevailing or dominant color that occurs in the document. This determination is made more accurate and potentially faster by selecting particular areas within the image to examine. For example, by examining the outer margins of the document that generally fall outside of the printable area it may be assumed that the dominant color by frequency within that area represents the background color for the document. By way of illustration, office documents typically have a margin from about one inch to one and one-half inches.

The accuracy of determining the background color can be increased by examining more than one margin or edge of the document (e.g., examine two, three, or four sides of the document). The resulting histograms are correlated with the histogram of the entire image. If insufficient correlation is found between the dominant colors from each histogram, the background may be left unchanged. For instance, a heuristic approach backed with light testing shows that for a facsimile document, a histogram of the top 64 lines of a scanned-page provides sufficient data to determine the background color. When the document is going to be faxed, color data of the scan can be converted to mono-chrome for ease of calculating the histogram and for conserving random access memory (RAM) within the device.

According to block 210, a median value of the background color occurring in the margin of the document is calculated.

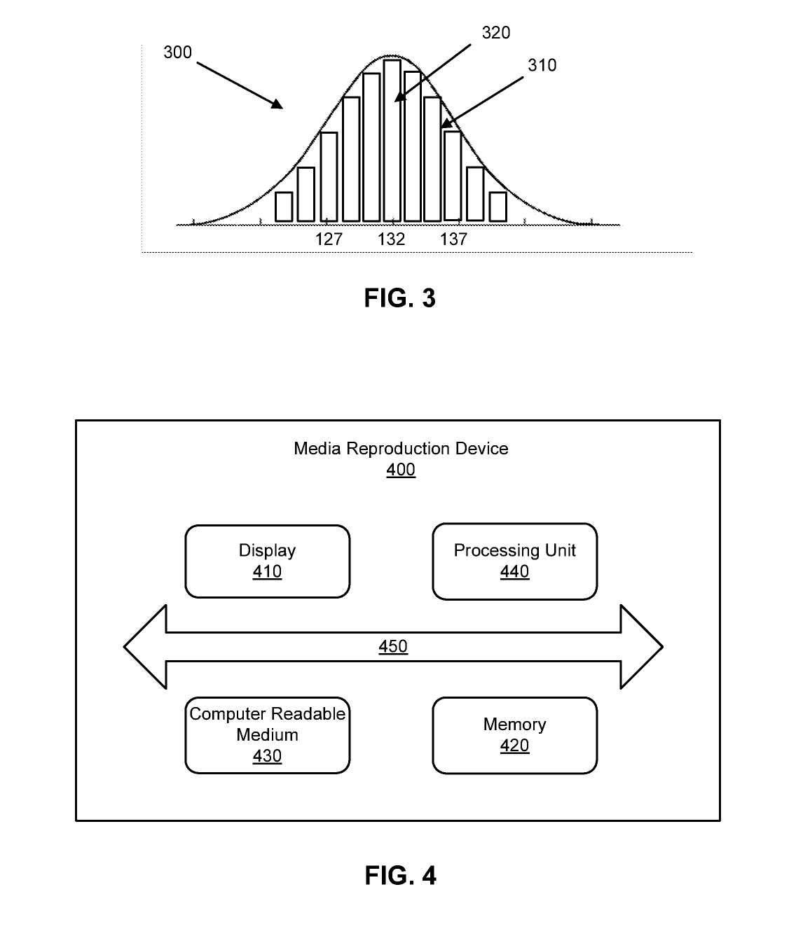

FIG. 3 is a histogram 300 of pixel values extracted from a document to determine the background color in accordance with an example embodiment.

The histogram 300 includes a plurality of pixel values 310 discovered in the margin of the document. The median pixel value 320 is 132, and this value determines the background color for the document.

According to block 220, a determination is made of the pixels in the document that have a color within a range or a percentage of the median value. For example, pixels within one standard deviation or a predetermined percentage are within an acceptable range. As shown in FIG. 3, pixels within the range of 127 to 137 can be selected.

According to block 230, the pixels within the range or percentage are changed to have the median value or changed to have a single color in order to reduce background noise in the document.

Once the median background color is determined, an optimal percentage or range of pixels is calculated, and pixels in this percentage or range are snapped to median value. By way of example, this process can snap pixels plus or minus five points to the median value. Alternatively, an arithmetic mean out to one standard deviation could be used. As yet another example, pixels within a predetermined percentage of the median value are changed to the median value.

Instead of changing the pixels within the range to the median value, the pixels can be changes to another value. For example, pixels within a specified range or percentage of the median value are changed to the color white or another color suitable for transmission. A one-dimensional Look-up Table (LUT) is generated or used to assist in snapping pixels to a median value. By determining the background color from the margins of a first strip, the LUT is adapted while the first strip has been scanned and applied to future strips of the scan.

The following example illustrates changing a range of pixels to a median value. Given pink paper with a histogram-determined mean background color of 132, a typical fax-scan would leave a number of background pixels on, which results in noise. This noise, in turn, results in a facsimile that has poor quality and a long run length compression, which increases the time to store and transmit the facsimile. By snapping pixels in the range of 128-137 to 132, the background noise is reduced, and the compression ratio is equivalent to that of a similar original on white paper (where pixel values over 240 would have been pushed to 255). If configured either statically or dynamically, the pixel values in the range 128-137 can be mapped in the LUT to 255. This mapping removes the poor compressing color variation of the background and the background color from the entire image. This process leaves the edges of the text as sharp as they were in the original document and achieves the compression benefiting noise removal without high computational cost.

If LUT is not available, a comparison and replacement can be implemented in software code and then applied to each pixel as it moves through an image-processing pipeline. Another example is to use RGB scans instead of grayscale scans and determine whether or not colored paper is in use.

Example embodiments are utilized in a wide variety of electronic devices. These electronic devices include, but are not limited to, computers, servers, and media reproduction devices (MRD). As used herein, a media reproduction device or MRD is an electronic device that performs one or more of printing, copying, scanning, and sending/receiving facsimiles. In one example embodiment, the electronic media reproduction device is a multi-functional printing device that incorporates the functionality of a computer and/or one or more peripheral devices, such as a printer, copier, scanner, facsimile machine, telephone, etc.

According to block 240, an action is performed on the document. The action includes one or more of compressing the document, copying the document, printing the document, faxing the document, saving the document, displaying the document, performing OCR on the document, and transmitting the document over a network (such as the internet).

FIG. 4 is a block diagram of a media reproduction device 400 that determines a background color of a document in accordance with an example embodiment. The media reproduction device 400 includes a display 410, memory 420, computer readable medium 430 to detect document background color and change pixels to a value, a processing unit 440, and one or more busses or communication paths 450.

The processing unit 440 (such as a central processing unit, CPU, microprocessor, application-specific integrated circuit (ASIC), etc.) controls the overall operation of memory 420 (such as RAM for temporary data storage, read only memory (ROM) for permanent data storage, and firmware). The processing unit 440 communicates with the display 410, memory 420, and computer readable storage medium 430 to perform methods in accordance with example embodiments.

The MRD scans a document in preparation for faxing the document, copying the document, or performing another task, such as performing OCR on the document. The MRD uses histograms extracted from margins of the document or areas with no text or graphics to determine the background color, and then applies a non-linear transform to the pixels within the range of the background color to reduce or eliminate noise from the background. This process results in clear, highly compressible faxes, copies, and OCR scans and further saves toner on copies without incurring high computational costs and blurred edges.

Blocks discussed herein can be automated and executed by a computer or electronic device. The term “automated” means controlled operation of an apparatus, system, and/or process using computers and/or mechanical/electrical devices without the necessity of human intervention, observation, effort, and/or decision.

The methods in accordance with example embodiments are provided as examples, and examples from one method should not be construed to limit examples from another method. Further, methods discussed within different figures can be added to or exchanged with methods in other figures. Further yet, specific numerical data values (such as specific quantities, numbers, categories, etc.) or other specific information should be interpreted as illustrative for discussing example embodiments. Such specific information is not provided to limit example embodiments.

In some example embodiments, the methods illustrated herein and data and instructions associated therewith are stored in respective storage devices, which are implemented as computer-readable and/or machine-readable storage media, physical or tangible media, and/or non-transitory storage media. These storage media include different forms of memory including semiconductor memory devices such as DRAM, or SRAM, Erasable and Programmable Read-Only Memories (EPROMs), Electrically Erasable and Programmable Read-Only Memories (EEPROMs) and flash memories; magnetic disks such as fixed, floppy and removable disks; other magnetic media including tape; optical media such as Compact Disks (CDs) or Digital Versatile Disks (DVDs). Note that the instructions of the software discussed above can be provided on computer-readable or machine-readable storage medium, or alternatively, can be provided on multiple computer-readable or machine-readable storage media distributed in a large system having possibly plural nodes. Such computer-readable or machine-readable medium or media is (are) considered to be part of an article (or article of manufacture). An article or article of manufacture can refer to any manufactured single component or multiple components.

What is claimed is:

1. A method executed by a media reproduction device, comprising:
receiving, at the media reproduction device, an image of a document;
determining, by the media reproduction device, a background color of the document in an area without text and graphics;
replacing, by the media reproduction device, a range of pixel values of the background color with a new value;
compressing, by the media reproduction device, the document with the range of pixel values that are changed to the new value; and
transmitting, by the media reproduction device, the compressed document.

2. The method of claim 1 further comprising, determining the background color with histograms.

3. The method of claim 1 further comprising, examining a margin of the document to determine the background color.

4. The method of claim 1 further comprising, determining a dominant color that occurs in the area without text and graphics to determine the background color.

5. The method of claim 1 further comprising, replacing the range of pixel values of the background color with a white color.

6. A non-transitory computer readable storage medium comprising instructions that when executed causes a media reproduction device to:
calculate a histogram that determines a background color occurring in a margin of a colored scanned document;
calculate a median value of the background color occurring in the margin of the colored scanned document;
determine pixels in the document that have a color within a range of the median value; and
reduce background noise in the document by changing the pixels within the range to have the median value.

7. The non-transitory computer readable storage medium of claim 6 including instructions to further cause the media reproduction device to: snap pixels within one standard deviation of the median value to a single color.

8. The non-transitory computer readable storage medium of claim 6 including instructions to further cause the media reproduction device to: map the pixels within the range to a one-dimensional Look-up Table (LUT) to assist in changing the pixels within the range to have the median value.

9. The non-transitory computer readable storage medium of claim 6 including instructions to further cause the media reproduction device to: snap pixels within a percentage of the median value to the median value.

10. The non-transitory computer readable storage medium of claim 6 including instructions to further cause the media reproduction device to: convert the colored scanned document from red, green, blue (RGB) color space to YCbCr color space.

11. A media reproduction device, comprising:
a memory storing instructions; and
a processor that executes the instructions to:
retrieve an image of a document;
determine a background color of the document by examining colors occurring in a margin of the document;
replace a range of pixel values of the background color with a new value; and
storing the document in the memory.

12. The media reproduction device of claim 10, wherein the processor further executes the instructions to compress the document and fax the compressed document.

13. The media reproduction device of claim 10, wherein the processor further executes the instructions to perform optical character recognition on the document.

14. The media reproduction device of claim 10, wherein the processor further executes the instructions to print the document.

15. The media reproduction device of claim 10, wherein the processor further executes the instructions to use a histogram to determine the background color.
